(19) United States
(12) Patent Application Publication
(10) Pub. No.: US 2020/0365123 A1
(43) Pub. Date: Nov. 19, 2020

(54) INFORMATION PROCESSING METHOD

(71) Applicant: YAMAHA Corporation, Shizuoka (JP)

(72) Inventor: Yo MAEZAWA, Shizuoka (JP)

(21) Appl. No.: 16/985,434

(22) Filed: Aug. 5, 2020

Related U.S. Application Data
(63) Continuation of application No. PCT/JP2019/004114, filed on Feb. 5, 2019.

(30) Foreign Application Priority Data
Feb. 6, 2018 (JP) 2018-019140

(51) Int. Cl. G10G 1/00; G06F 9/451; G06F 3/16

(52) U.S. Cl. CPC G10G 1/00; G06T 13/40; G06F 3/167; G06F 9/453

(57) ABSTRACT

Disclosed herein is an information processing method including: sequentially obtaining performance data including sounding of a musical note on a time axis, setting an analysis period in the obtained performance data, the analysis period including a predetermined time, a first period preceding the time, and a second period succeeding the time, and sequentially generating, from the performance data, analysis data including a time series of musical notes included in the first period and a time series of musical notes included in the second period and predicted from the time series of the musical notes in the first period; and sequentially generating, from the analysis data, control data for controlling a movement of a virtual object representing a performer.

### CROSS-REFERENCE TO RELATED APPLICATIONS

This application is a continuation application of International Application No. PCT/JP2019/004114, filed on Feb. 5, 2019, which claims priority to Japanese Patent Application No. 2018-019140, filed in Japan on Feb. 6, 2018. The entire disclosures of International Application No. PCT/JP2019/004114 and Japanese Patent Application No. 2018-019140 are hereby incorporated herein by reference.

### BACKGROUND

The present disclosure relates to an information processing method, an information processing device, a performance system, and an information processing program for controlling a movement of an object representing a performer such as a player.

Technologies of controlling a movement of an object as an image representing a player according to performance data of a musical piece have been proposed in the related art (Japanese Patent Laid-Open No. 2000-10560; Japanese Patent Laid-Open No. 2010-134790; Kazuki Yamamoto and five others “Automatic generation of natural finger movement CG in piano performance,” TVRSJ Vol. 15 No. 3 p. 495-502, 2010; and Nozomi Kugimoto and five others “CG representation of piano performance movement using motion capture and application to music performance interface,” Research Report of Information Processing Society of Japan, 2007-MUS-72 (15), 2007 Dec. 10). For example, Japanese Patent Laid-Open No. 2000-10560 discloses a technology of generating a moving image of a player playing the musical piece according to pitches specified by the performance data.

### SUMMARY

Under the technology of Japanese Patent Laid-Open No. 2000-10560, performance data stored in a storage device in advance is used to control the movement of the object. Hence, it is difficult to appropriately control the movement of the object under conditions where time points of sounding of musical notes specified by the performance data change dynamically. In consideration of the above circumstances, it is desirable to control the movement of the object appropriately even under conditions where a time point of sounding of each musical note is variable.

According to an embodiment of the present disclosure, there is provided an information processing method including: sequentially obtaining performance data including sounding of a musical note on a time axis, setting an analysis period in the obtained performance data, the analysis period including a predetermined time, a first period preceding the time, and a second period succeeding the time, and sequentially generating, from the performance data, analysis data including a time series of musical notes included in the first period and a time series of musical notes included in the second period and predicted from the time series of the musical notes in the first period; and sequentially generating, from the analysis data, control data for controlling a movement of a virtual object representing a performer.

According to another embodiment of the present disclosure, there is provided an information processing device including: an analysis data generating module configured to sequentially obtain performance data including sounding of a musical note on a time axis, set an analysis period in the obtained performance data, the analysis period including a predetermined time, a first period preceding the time, and a second period succeeding the time, and sequentially generate, from the performance data, analysis data including a time series of musical notes included in the first period and a time series of musical notes included in the second period and predicted from the time series of the musical notes in the first period; and a control data generating module configured to sequentially generate, from the analysis data, control data for controlling a movement of a virtual object representing a performer.

According to a further embodiment of the present disclosure, there is provided a performance system including: a sound collecting device configured to obtain a sound signal of sound sounded in performance; the above-described information processing device; and a display device configured to display the virtual object; the information processing device including a display control module configured to make the display device display the virtual object from the control data.

According to a yet further embodiment of the present disclosure, there is provided an information processing program for a computer, including: by an analysis data generating module, sequentially obtaining performance data including sounding of a musical note on a time axis, setting an analysis period in the obtained performance data, the analysis period including a predetermined time, a first period preceding the time, and a second period succeeding the time, and generating analysis data including a time series of musical notes included in the first period and a time series of musical notes included in the second period and predicted from the time series of the musical notes in the first period; and by a control data generating module, sequentially generating, from the analysis data, control data for controlling a movement of a virtual object representing a performer.

### BRIEF DESCRIPTION OF THE DRAWINGS

FIG. 1 is a block diagram illustrating a configuration of a performance system according to an embodiment of the present disclosure;

FIG. 2 is a block diagram illustrating a functional configuration of an information processing device;

FIG. 3 is a diagram of assistance in explaining a display screen of a display device;

FIG. 4 is a diagram of assistance in explaining analysis data;

FIG. 5 is a diagram of assistance in explaining control data;

FIG. 6 is a block diagram illustrating a configuration of a control data generating module;

FIG. 7 is a block diagram illustrating a configuration of a first statistical model;

FIG. 8 is a block diagram illustrating a configuration of a second statistical model;

FIG. 9 is a diagram of assistance in explaining teacher data; and

FIG. 10 is a flowchart illustrating movement control processing.

### DETAILED DESCRIPTION OF THE PREFERRED EMBODIMENTS

A performance system according to one embodiment of the present disclosure will hereinafter be described.

<1. Outline of Performance System>

FIG. 1 is a block diagram illustrating a configuration of a performance system 100 according to a preferred mode of the present disclosure. The performance system 100 is a computer system installed in a space such as an acoustic hall in which a player P is located. The player P is, for example, a player of a musical instrument or a singer of a musical piece. The performance system 100 automatically plays a musical piece in parallel with the performance of the musical piece by the player P.

<2. Hardware Configuration of Performance System>

As illustrated in FIG. 1, the performance system 100 includes an information processing device 11, a performance device 12, a sound collecting device 13, and a display device 14. The information processing device 11 is a computer system that controls each element of the performance system 100. The information processing device 11 is, for example, implemented by an information terminal such as a tablet terminal or a personal computer.

The performance device 12 automatically plays a musical piece under control of the information processing device 11. Specifically, the performance device 12 is an automatic playing musical instrument including a driving mechanism 121 and a sounding mechanism 122. In a case where the automatic playing musical instrument is an automatic playing piano, for example, the automatic playing piano includes a keyboard and a string (sounding body) corresponding to each key of the keyboard. As with a keyboard instrument as a natural musical instrument, the sounding mechanism 122 includes, for each key of the keyboard, a string striking mechanism that sounds a string so as to be interlocked with a displacement of the key. The driving mechanism 121 automatically plays a target musical piece by driving the sounding mechanism 122. The automatic playing is realized when the driving mechanism 121 drives the sounding mechanism 122 according to an instruction from the information processing device 11. Incidentally, the information processing device 11 may be included in the performance device 12.

The sound collecting device 13 is a microphone that collects sound (for example, a musical instrument sound or a singing sound) sounded by the performance of the player P. The sound collecting device 13 generates a sound signal A indicating a waveform of the sound. Incidentally, the sound signal A output from an electric musical instrument such as an electric stringed instrument may be used. Hence, the sound collecting device 13 can be omitted. The display device 14 displays various kinds of images under control of the information processing device 11. For example, various kinds of displays such as a liquid crystal display panel or a projector are suitably used as the display device 14.

As illustrated in FIG. 1, the information processing device 11 is implemented by a computer system including a control device 111 and a storage device 112. The control device 111 is, for example, a processing circuit including a central processing unit (CPU), a random access memory (RAM), a read only memory (ROM), and the like. The control device 111 collectively controls each element (the performance device 12, the sound collecting device 13, and the display device 14) constituting the performance system 100. The control device 111 includes at least one circuit.

The storage device (memory) 112, for example, includes a publicly known recording medium such as a magnetic recording medium (hard disk drive) or a semiconductor recording medium (solid state drive), or a combination of a plurality of kinds of recording media. The storage device (memory) 112 stores a program executed by the control device 111 and various kinds of data used by the control device 111. Incidentally, a storage device 112 separate from the performance system 100 (for example, a cloud storage) may be prepared, and the control device 111 may write into and read from the storage device 112 via a communication network such as a mobile communication network or the Internet. That is, the storage device 112 may be omitted from the performance system 100.

The storage device 112 according to the present embodiment stores musical piece data D. The musical piece data D is, for example, a file (standard MIDI file (SMF)) in a format complying with a musical instrument digital interface (MIDI) standard. The musical piece data D specifies a time series of musical notes constituting a musical piece. Specifically, the musical piece data D is time series data formed by arranging performance data E specifying the musical notes and giving instructions for performance and time data specifying a time point of readout of each piece of performance data E. The performance data E, for example, specifies pitches and strengths of the musical notes. The time data, for example, specifies intervals of readout of successive pieces of performance data E.

<3. Software Configuration of Performance System>

A software configuration of the information processing device 11 will next be described. FIG. 2 is a block diagram illustrating a functional configuration of the information processing device 11. As illustrated in FIG. 2, the control device 111 implements a plurality of functions (a performance control module 21, an analysis data generating module 22, a control data generating module 23, and a display control module 24) illustrated in FIG. 2 by executing a plurality of tasks according to the program stored in the storage device 112. Incidentally, the functions of the control device 111 may be implemented by a set of a plurality of devices (that is, a system), or a part or the whole of the functions of the control device 111 may be implemented by a dedicated electronic circuit (for example, a signal processing circuit). In addition, a server device located in a position separated from the space such as the acoustic hall in which the performance device 12, the sound collecting device 13, and the display device 14 are installed may implement a part or the whole of the functions of the control device 111.

<3-1. Performance Control Module>

The performance control module 21 is a sequencer that sequentially outputs each piece of performance data E of the musical piece data D to the performance device 12. The performance device 12 plays the musical notes specified by the performance data E sequentially supplied from the performance control module 21. The performance control module 21 in the present embodiment variably controls timing of output of the performance data E to the performance device 12 such that the automatic performance of the performance device 12 follows the actual performance of the player P. Timing in which the player P plays each musical note of the musical piece dynamically changes due to musical expression intended by the player P and the like. Hence, the timing in which the performance control module 21 outputs the performance data E to the performance device 12 is also variable.

Specifically, the performance control module 21 estimates the timing of the actual performance of the player P within the musical piece (which timing will hereinafter be referred to as “performance timing”) by analyzing the sound signal A. The estimation of the performance timing is sequentially performed in parallel with the actual performance of the player P. A publicly known acoustic analysis technology (score alignment) of Japanese Patent Laid-Open No. 2015-79183 or the like, for example, can be arbitrarily adopted for the estimation of the performance timing. The performance control module 21 outputs each piece of performance data E to the performance device 12 such that the automatic performance of the performance device 12 synchronizes with the progress of the performance timing. Specifically, each time the performance timing arrives in timing specified by each piece of time data of the musical piece data D, the performance control module 21 outputs the performance data E corresponding to the time data to the performance device 12. Hence, the progress of the automatic performance of the performance device 12 synchronizes with the actual performance of the player P. That is, an atmosphere is produced as if the performance device 12 and the player P played in concert by cooperating with each other.

<3-2. Display Control Module>

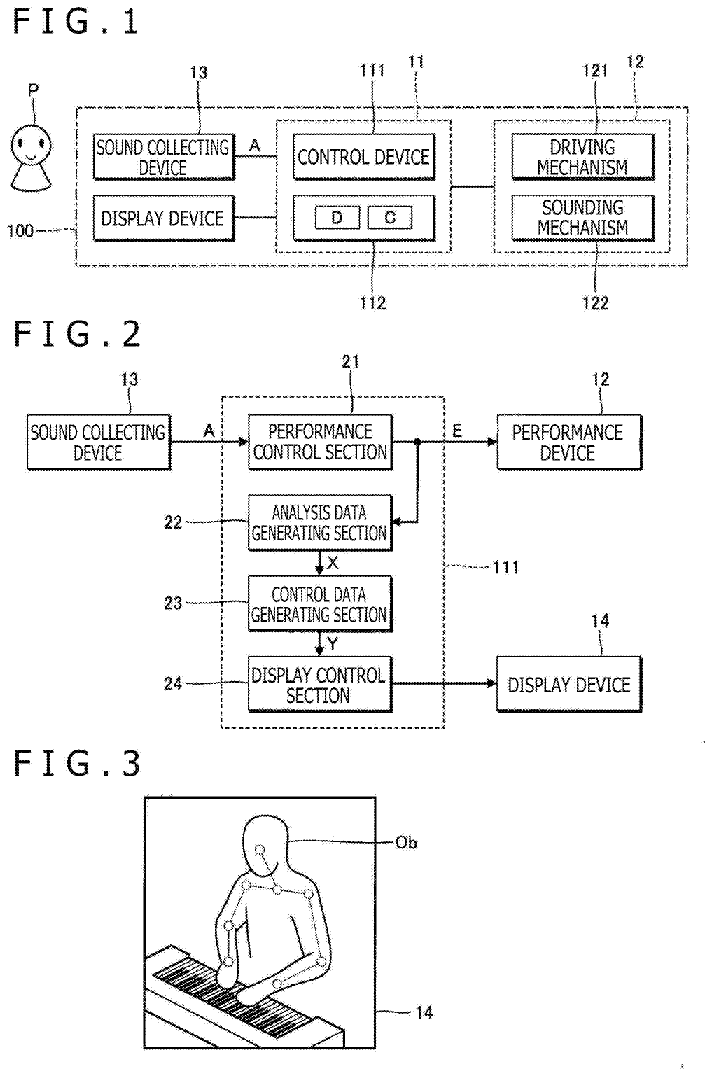

As illustrated in FIG. 3, the display control module 24 displays, on the display device 14, an image Ob representing a virtual player (which image will hereinafter be referred to as a “player object (virtual object)).” An image representing a keyboard instrument played by the player object Ob is also displayed on the display device 14 together with the player object Ob. The player object Ob illustrated in FIG. 3 is an image representing an upper body including both arm portions, a chest portion, and a head portion of the player. The display control module 24 dynamically changes the player object Ob in parallel with the automatic performance of the performance device 12. Specifically, the display control module 24 controls the player object Ob such that the player object Ob performs a performance movement operatively associated with the automatic performance of the performance device 12. For example, the player object Ob sways the body to a rhythm of the automatic performance, and the player object Ob performs a key pressing movement when a musical note is sounded by the automatic performance. Hence, a user viewing the image displayed by the display device 14 (which user is, for example, the player P or a spectator) can perceive a feeling as if the player object Ob played the musical piece. The analysis data generating module 22 and the control data generating module 23 in FIG. 2 are elements for operatively associating the movement of the player object Ob with the automatic performance.

<3-3. Analysis Data Generating Module>

The analysis data generating module 22 generates analysis data X representing the time series of each automatically played musical note. The analysis data generating module 22 sequentially obtains the performance data E output by the performance control module 21, and generates the analysis data X from the time series of the performance data E. The analysis data X is sequentially generated for each of a plurality of unit periods (frames) on a time axis in parallel with the obtainment of the performance data E output by the performance control module 21. That is, the analysis data X is sequentially generated in parallel with the actual performance of the player P and the automatic performance of the performance device 12.

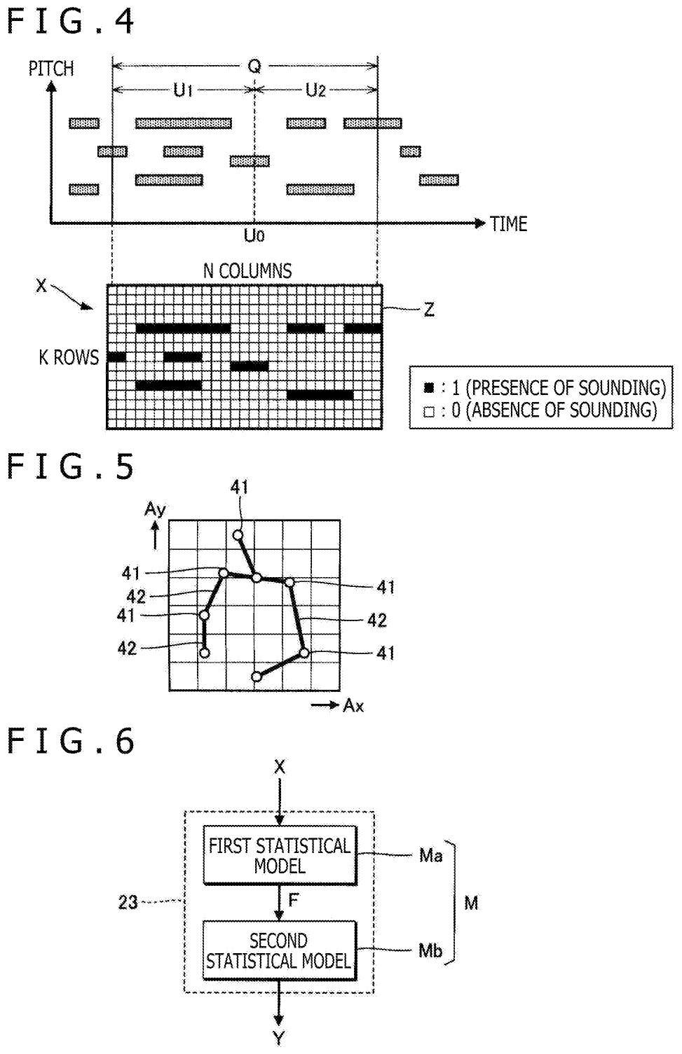

FIG. 4 is a diagram of assistance in explaining the analysis data X. The analysis data X in the present embodiment includes a matrix Z of K rows and N columns (which matrix will hereinafter be referred to as a “performance matrix”) (K and N are a natural number). The performance matrix Z is a binary matrix representing the time series of the performance data E sequentially output by the performance control module 21. A horizontal direction of the performance matrix Z corresponds to the time axis. One arbitrary column of the performance matrix Z corresponds to one unit period of N (for example, 60) unit periods. In addition, a vertical direction of the performance matrix Z corresponds to a pitch axis. One arbitrary row of the performance matrix Z corresponds to one pitch of K (for example, 128) pitches. An element in a kth row and an nth column (k=1 to K, and n=1 to N) of the performance matrix Z indicates whether or not a pitch corresponding to the kth row is sounded in a unit period corresponding to the nth column. Specifically, an element in which the corresponding pitch is sounded is set to “1,” and an element in which the corresponding pitch is not sounded is set to “0.”

The analysis data X generated for one unit period U0 on the time axis (which unit period will hereinafter be referred to as a “specific unit period,” and also corresponds to a “predetermined time” in the present disclosure) represents a time series of musical notes within an analysis period Q including the specific unit period U0, as illustrated in FIG. 4. Each of the plurality of unit periods on the time axis is sequentially selected as the specific unit period U0 in time series order. The analysis period Q is a period constituted of N unit periods including the specific unit period U0. That is, the nth column of the performance matrix Z corresponds to the nth unit period of the N unit periods constituting the analysis period Q. Specifically, the analysis period Q includes one specific unit period U0 (present), a period U1 (first period) located in front (past) of the specific unit period U0, and a period U2 (second period) located in the rear (future) of the specific unit period U0. The period U1 and the period U2 are each a period of approximately one second including a plurality of unit periods.

Elements corresponding to each unit period within the period U1 of the performance matrix Z are set to “1” or “0” according to each piece of performance data E already obtained from the performance control module 21. On the other hand, elements corresponding to each unit period within the period U2 of the performance matrix Z (that is, elements corresponding to a future period in which the performance data E is not obtained yet) are predicted from the time series of musical notes before the specific unit period U0 and the musical piece data D. A publicly known time series analysis technology (for example, linear prediction or a Kalman filter) is arbitrarily adopted for the prediction of the elements corresponding to each unit period within the period U2. As is understood from the above description, the analysis data X is data including the time series of the musical notes played in the period U1 and the time series of the musical notes predicted to be played in the subsequent period U2 on the basis of the time series of the musical notes in the period U1.

<3-4. Control Data Generating Module>

The control data generating module 23 in FIG. 2 generates control data Y for controlling the movement of the player object Ob from the analysis data X generated by the analysis data generating module 22. The control data Y is sequentially generated for each unit period. Specifically, the control data Y of one arbitrary unit period is generated from the analysis data X of the unit period. The control data Y is generated in parallel with the output of the performance data E by the performance control module 21. That is, the time series of the control data Y is generated in parallel with the actual performance of the player P and the automatic performance of the performance device 12. As illustrated above, in the present embodiment, the common performance data E is used for the automatic performance of the performance device 12 and the generation of the control data Y. Hence, as compared with a configuration in which separate pieces of data are used for the automatic performance of the performance device 12 and the generation of the control data Y, there is an advantage of simplifying processing for making the object perform a movement operatively associated with the automatic performance of the performance device 12.

FIG. 5 is a diagram of assistance in explaining the player object Ob and the control data Y. As illustrated in FIG. 5, a skeleton of the player object Ob is expressed by a plurality of control points 41 and a plurality of coupling portions 42 (links). Each control point 41 is a point movable within a virtual space. A coupling portion 42 is a straight line that couples control points 41 to each other. As is understood from FIG. 3 and FIG. 5, the coupling portions 42 and the control points 41 are set not only to both arm portions directly related to the performance of the musical instrument but also to the chest portion and the head portion swaying during the performance. The movement of the player object Ob is controlled by moving each control point 41. As described above, in the present embodiment, the control points 41 are set not only to both arm portions but also to the chest portion and the head portion, and therefore the player object Ob can be made to perform a natural performance movement including not only a movement of playing the musical instrument by both arm portions but also a movement of swaying the chest portion and the head portion during the performance. That is, a representation can be realized such that the player object Ob automatically plays as a virtual player. Incidentally, the positions or number of the control points 41 and the coupling portions 42 is arbitrary, and is not limited to the above illustration.

The control data Y generated by the control data generating module 23 is a vector indicating the position of each of the plurality of control points 41 within a coordinate space. As illustrated in FIG. 5, the control data Y in the present embodiment represents coordinates of each control point 41 within a two-dimensional coordinate space in which an Ax axis and an Ay axis orthogonal to each other are set. The coordinates of each control point 41 represented by the control data Y are normalized such that the plurality of control points 41 have an average of zero and a variance of one. The vector formed by arranging a coordinate on the Ax axis and a coordinate on the Ay axis for each of the plurality of control points 41 is used as the control data Y. However, the form of the control data Y is arbitrary. The time series of the control data Y illustrated above represents the movement of the player object Ob (that is, the movement of each control point 41 and each coupling portion 42 with the passage of time).

<3-5. Generation of Control Data Y>

As illustrated in FIG. 6, the control data generating module 23 in the present embodiment generates the control data Y from the analysis data X by using a learned model (machine learning model) M. The learned model M is a statistical prediction model (typically a neural network) learning a relation between the analysis data X and the control data Y. The learned model M outputs the control data Y in response to input of the analysis data X. As illustrated in FIG. 6, the learned model M in the present embodiment has a configuration obtained by connecting a first statistical model Ma and a second statistical model Mb in series with each other.

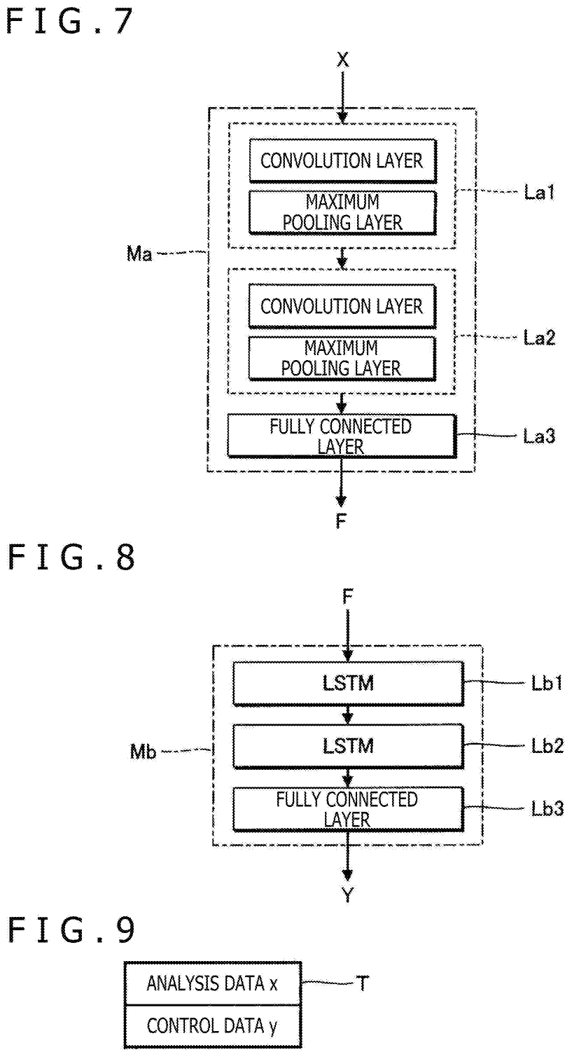

The first statistical model Ma has the analysis data X as input, and generates a feature vector F indicating a feature of the analysis data X as output. A convolutional neural network (CNN) suitable for feature extraction, for example, is suitably used as the first statistical model Ma. As illustrated in FIG. 7, the first statistical model Ma has a configuration obtained by stacking a first layer La1, a second layer La2, and a fully connected layer La3, for example. The first layer Lal and the second layer La2 each include a convolution layer and a maximum pooling layer. A lower-dimensional feature vector F than the analysis data X is thus generated as output such that the feature vector F summarizes the analysis data X. By generating such a feature vector F, and setting the feature vector F as input to the second statistical model Mb to be described next, it is possible to suppress shifts in the above-described control points 41 in the ultimately output control data Y even when the analysis data X including slightly shifted musical notes (musical notes slightly changed in timing or pitch) is input, for example. That is, even when the analysis data X having slightly different performance data E is input, a great change in the movement of the generated player object Ob can be suppressed.

The second statistical model Mb generates the control data Y according to the feature vector F. A recurrent neural network (RNN) including a long short term memory (LSTM) unit suitable for processing time series data, for example, is suitably used as the second statistical model Mb. Specifically, as illustrated in FIG. 8, the second statistical model Mb has a configuration obtained by stacking a first layer Lb1, a second layer Lb2, and a fully connected layer Lb3, for example. The first layer Lb1 and the second layer Lb2 each include an LSTM unit. It is thereby possible to generate the control data Y representing a smooth movement of the player object Ob when the low-dimensional feature vector F compressed as described above is set as input.

As illustrated above, according to the present embodiment, appropriate control data Y corresponding to the time series of the performance data E can be generated by a combination of a CNN and an RNN. However, the configuration of the learned model M is arbitrary, and is not limited to the above illustration.

The learned model M is implemented by a combination of a program (for example, a program module constituting artificial intelligence software) making the control device 111 perform an operation of generating the control data Y from the analysis data X and a plurality of coefficients C applied to the operation. The plurality of coefficients C are set by machine learning (deep learning, in particular) using a large number of pieces of teacher data T, and are retained in the storage device 112. Specifically, a plurality of coefficients C defining the first statistical model Ma and a plurality of coefficients C defining the second statistical model Mb are collectively set by machine learning using a plurality of pieces of teacher data T.

FIG. 9 is a diagram of assistance in explaining the teacher data T. As illustrated in FIG. 9, each of the plurality of pieces of teacher data T represents a combination of analysis data x and control data y. The plurality of pieces of teacher data T for machine learning are collected by observing a situation in which a particular player (hereinafter referred to as a “sample player”) actually plays the same kind of musical instrument as the musical instrument virtually played by the player object Ob. Specifically, the analysis data x representing a time series of musical notes played by the sample player is sequentially generated. In addition, the position of each control point of the sample player is identified from a moving image imaging a state of performance by the sample player, and the control data y representing the position of each control point is generated. Hence, the two-dimensional coordinate space in which the above-described player object appears is generated on the basis of a camera angle at which the sample player is photographed. Hence, when the camera angle is changed, a setting of the two-dimensional coordinate space also changes. One piece of teacher data T is thus generated by making the analysis data x and the control data y generated for one time point on the time axis correspond to each other. Incidentally, the teacher data T may be collected from a plurality of sample players.

In machine learning, the plurality of coefficients C of the learned model M are set by, for example, an error back propagation method or the like so as to minimize a loss function indicating a difference between the control data Y generated when the analysis data x of the teacher data T is input to a tentative model and the control data y of the teacher data T (that is, a correct answer). For example, an average absolute error between the control data Y generated by the tentative model and the control data y of the teacher data T is suitable as the loss function.

Incidentally, a mere condition of the minimization of the loss function does not guarantee that intervals between the control points 41 (that is, a total length of each coupling portion 42) are constant. Hence, there is a possibility that each coupling portion 42 of the player object Ob extends or contracts unnaturally. Accordingly, in the present embodiment, the plurality of coefficients C of the learned model M are optimized under a condition of minimizing temporal changes in the intervals between the control points 41 represented by the control data y in addition to the condition of minimizing the loss function. It is therefore possible to make the player object Ob perform a natural movement in which the extension or contraction of each coupling portion 42 is reduced. The learned model M generated by the machine learning described above outputs statistically appropriate control data Y with respect to unknown analysis data X under a tendency extracted from a relation between the contents of performance by the sample player and a body movement during the performance. In addition, the first statistical model Ma is learned such that an optimum feature vector F is extracted to establish the above relation between the analysis data X and the control data Y.

The display control module 24 in FIG. 2 makes the display device 14 display the player object Ob according to the control data Y generated for each unit period by the control data generating module 23. Specifically, the state of the player object Ob is updated in each unit period such that each control point 41 is located at coordinates specified by the control data Y. When the above control is performed in each unit period, each control point 41 moves with the passage of time. That is, the player object Ob performs a performance movement. As is understood from the above description, the time series of the control data Y defines the movement of the player object Ob.

<4. Processing of Controlling Player Object>

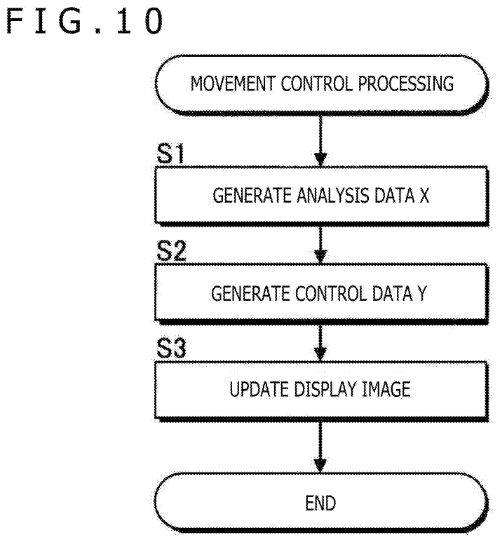

FIG. 10 is a flowchart illustrating processing for controlling the movement of the player object Ob (which processing will hereinafter be referred to as “movement control processing”). The movement control processing is performed in each unit period on the time axis. When the movement control processing is started, the analysis data generating module 22 generates the analysis data X including the time series of musical notes within the analysis period Q including the specific unit period U0 and periods (U1 and U2) in front and in the rear of the specific unit period U0 (S1). The control data generating module 23 generates the control data Y by inputting the analysis data X generated by the analysis data generating module 22 to the learned model M (S2). The display control module 24 updates the player object Ob according to the control data Y generated by the control data generating module 23 (S3). The generation of the analysis data X (S1), the generation of the control data Y (S2), and the display of the player object Ob (S3) are performed in parallel with the obtainment of the performance data E.

<5. Features>

As described above, the present embodiment generates the control data Y for controlling the movement of the player object Ob from the analysis data X within the analysis period Q including the specific unit period U0 and the periods in front and in the rear of the specific unit period U0 in parallel with the obtainment of the performance data E. That is, the control data Y is generated from the performance data E of the period U1 in which performance is already completed and the performance data of the future period U2 which performance data is predicted from the performance data E of the period U1. Hence, the movement of the player object Ob can be controlled appropriately even though timing of sounding of each musical note within a musical piece is variable. That is, the movement of the player object Ob can be controlled so as to correspond to variations in performance by the player P more reliably. For example, when a performance speed of the player P becomes slow suddenly, the movement of the player object Ob which movement corresponds to the performance speed can be generated instantly by using data predicted from the performance data of a period in which performance is already completed (data of the period U2).

In addition, in playing a musical instrument, the player performs a preparatory movement, and plays the musical instrument immediately after the preparatory movement. Therefore, it is difficult to generate the movement of the player object reflecting such a preparatory movement when past performance data is simply set as input. Hence, the control data Y such as one making the player object Ob perform the preparatory movement can be generated by setting also the performance data of the future period as input as described above.

In addition, in the present embodiment, the control data Y is generated by inputting the analysis data X to the learned model M. It is therefore possible to generate various control data Y representing a statistically appropriate movement with respect to unknown analysis data X under a tendency identified from a plurality of pieces of teacher data T used for machine learning. In addition, there is an advantage of being able to control the movement of player objects Ob of various sizes by the control data Y because the coordinates indicating the position of each of the plurality of control points 41 are normalized. That is, in the two-dimensional coordinate space, the player object can perform an average movement even when the position of each control point of the sample player in the teacher data varies or there is a large difference in physical constitution between a plurality of sample players, for example.

<6. Modifications>

Modes of concrete modifications added to each mode illustrated above will be illustrated in the following. Two or more modes arbitrarily selected from the following illustration may be integrated with each other as appropriate within a scope where no mutual inconsistency arises.

(1) In the foregoing embodiment, a binary matrix representing the time series of musical notes within the analysis period Q is illustrated as the performance matrix Z. However, the performance matrix Z is not limited to the above illustration. For example, a performance matrix Z representing performance strengths (volumes) of musical notes within the analysis period Q may be generated. Specifically, one element in the kth row and the nth column of the performance matrix Z represents a strength with which the pitch corresponding to the kth row is played in the unit period corresponding to the nth column. According to the above configuration, the performance strength of each musical note is reflected in the control data Y, and therefore a tendency for the movement of the player to differ according to the magnitude of the performance strength can be imparted to the movement of the player object Ob.

(2) In the foregoing embodiment, the feature vector F generated by the first statistical model Ma is input to the second statistical model Mb. However, the feature vector F generated by the first statistical model Ma may be input to the second statistical model Mb after another element is added to the feature vector F generated by the first statistical model Ma. For example, the feature vector F may be input to the second statistical model Mb after a time point (for example, a distance from a bar line) of performance of the musical piece by the player P, a performance speed, information indicating the time of the musical piece, or performance strength (for example, a strength value or a strength symbol) is added to the feature vector F.

(3) In the foregoing embodiment, the performance data E used to control the performance device 12 is used also to control the player object Ob. However, the control of the performance device 12 using the performance data E may be omitted. In addition, the performance data E is not limited to data complying with the MIDI standard. For example, a frequency spectrum of the sound signal A output by the sound collecting device 13 may be used as the performance data E. The time series of the performance data E corresponds to a spectrogram of the sound signal A. The frequency spectrum of the sound signal A corresponds to data representing the sounding of musical notes because peaks are observed in bands corresponding to the pitches of the musical notes sounded by the musical instrument. As is understood from the above description, the performance data E is comprehensively expressed as data representing the sounding of the musical notes.

(4) In the foregoing embodiment, the player object Ob representing the player playing a musical piece to be automatically played is illustrated. However, the mode of the object whose movement is controlled by the control data Y is not limited to the above illustration. For example, an object representing a dancer performing a dance so as to be operatively associated with the automatic performance of the performance device 12 may be displayed on the display device 14. Specifically, positions of control points are identified from a moving image imaging a dancer dancing to the musical piece, and data indicating the position of each control point is used as the control data y of the teacher data T. Hence, the learned model M learns a tendency extracted from a relation between played musical notes and the movement of a body of the dancer. As is understood from the above description, the control data Y is comprehensively expressed as data for controlling the movement of the object representing the performer (for example, the player or the dancer).

(5) The functions of the information processing device according to the foregoing embodiment are implemented by cooperation between a computer (for example, the control device 111) and a program. The program according to the foregoing embodiment is provided in a form of being stored on a recording medium readable by a computer, and installed on the computer. The recording medium is, for example, a non-transient (non-transitory) recording medium, and an optical recording medium (optical disc) such as a compact disc (CD)-ROM is a good example of the recording medium. However, the recording medium includes publicly known arbitrary forms of recording media such as a semiconductor recording medium, a magnetic recording medium, and the like. Incidentally, the non-transient recording medium includes arbitrary recording media excluding a transient propagating signal (transitory propagating signal), and volatile recording media are not excluded from the non-transient recording medium. In addition, the program may be provided to the computer in a form of distribution via a communication network.

(6) The entity that executes artificial intelligence software for implementing the learned model M is not limited to a CPU. For example, a processing circuit for a neural network such as a tensor processing unit or a neural engine or a digital signal processor (DSP) dedicated to artificial intelligence may execute the artificial intelligence software. In addition, a plurality of kinds of processing circuits selected from the above illustration may execute the artificial intelligence software in cooperation with each other.

(7) In the foregoing embodiment, the second statistical model Mb uses a neural network including an LSTM unit, but can also use an ordinary RNN. In addition, while the two statistical models Ma and Mb based on machine learning are used as the learned model M of the control data generating module 23 in the foregoing embodiment, the two statistical models Ma and Mb can also be implemented by one model. In addition, another prediction model other than machine learning or combined with machine learning may be used. For example, a model suffices which can generate control data representing the future movement of the virtual object from analysis data changing with the passage of time (combination of past data and future data) by analysis based on inverse kinematics.

(8) In the foregoing embodiment, the information processing device 11 includes the performance control module 21 and the display control module 24 in addition to the analysis data generating module 22 and the control data generating module 23. However, in the information processing method and the information processing device according to the present disclosure, the performance control module 21 and the display control module 24 are not essential, but it suffices to be able to generate the control data Y from the performance data E by at least the analysis data generating module 22 and the control data generating module 23. Hence, the analysis data X and the control data Y can also be generated using the performance data E created in advance, for example.

<Supplementary Notes>

The following constitution, for example, is grasped from the embodiment illustrated above.

An information processing method according to a preferred mode (first mode) of the present disclosure sequentially obtains performance data representing sounding of a musical note at a variable time point on a time axis, sequentially generates, for each of a plurality of unit periods, analysis data representing a time series of musical notes within an analysis period including the unit period and periods in front and in the rear of the unit period from a time series of the performance data in parallel with obtainment of the performance data, and sequentially generates control data for controlling a movement of an object representing a performer from the analysis data in parallel with the obtainment of the performance data. In the above mode, the control data for controlling the movement of the object is generated from the analysis data within the analysis period including the unit period and the periods in front and in the rear of the unit period in parallel with the obtainment of the performance data. Hence, the movement of the object can be controlled appropriately even under conditions where the time point of sounding of each musical note is variable.

The information processing method according to a suitable example (second mode) of the first mode makes a performance device automatically play by sequentially supplying the performance data to the performance device. In the above mode, the common performance data is used for the automatic performance of the performance device and the generation of the control data. Hence, there is an advantage of simplifying processing for making the object perform a movement operatively associated with the automatic performance of the performance device.

In a suitable example (third mode) of the second mode, the control data is data for controlling a movement of the object at a time of playing of a musical instrument. According to the above mode, a representation can be realized such that the object automatically plays as a virtual player.

It should be understood by those skilled in the art that various modifications, combinations, sub-combinations and alterations may occur depending on design requirements and other factors insofar as they are within the scope of the appended claims or the equivalent thereof.

What is claimed is:

1. An information processing method comprising:
acquiring performance data, generating analysis data based on the performance data, the analysis data including a time series of notes played in the first period and a time series of notes that are expected to be played in the second period; and
generating control data, by inputting the analysis data, to control a movement of a virtual object representing a performer.

2. The information processing method according to claim 1, further comprising:
supplying the performance data to a performance device for performing automatically.

3. The information processing method according to claim 1, further comprising:
generating the performance data from a sound signal of sound sounded in performance before generating the analysis data.

4. The information processing method according to claim 1, wherein
the control data is data for controlling the movement of the virtual object at a time of playing a musical instrument.

5. The information processing method according to claim 1, wherein
the virtual object is displayed in a two-dimensional coordinate space,
a plurality of control points representing a skeleton of the virtual object are set, and
the control data includes normalized coordinates indicating a position of each of the plurality of control points.

6. An information processing device comprising:
a control device including at least one processor; and
the control device including
an analysis data generating module configured to generate analysis data based on the performance data, the analysis data including a time series of notes played in the first period and a time series of notes that are expected to be played in the second period; and
a control data generating module configured to generate control data, by inputting the analysis data, to control a movement of a virtual object representing a performer.

7. The information processing device according to claim 6, wherein
the control data is data for controlling the movement of the virtual object at a time of playing a musical instrument.

8. The information processing device according to claim 6, wherein
the virtual object is displayed in a two-dimensional coordinate space,
a plurality of control points representing a skeleton of the virtual object are set, and
the control data includes normalized coordinates indicating a position of each of the plurality of control points.

9. The information processing device according to claim 6, further comprising:
a performance control module configured to make a performance device automatically play by sequentially supplying the performance data to the performance device.

10. The information processing device according to claim 6, further comprising:
a performance control module configured to generate the performance data from a sound signal of sound sounded in performance.

11. A performance system comprising:
a sound collecting device configured to obtain a sound signal of sound sounded in performance;
an information processing device including
an analysis data generating module configured to sequentially obtain performance data including sounding of a musical note on a time axis, set an analysis period in the obtained performance data, the analysis period including a predetermined time, a first period preceding the time, and a second period succeeding the time, and sequentially generate, from the performance data, analysis data including a time series of musical notes included in the first period and a time series of musical notes included in the second period and predicted from the time series of the musical notes in the first period, and
a control data generating module configured to sequentially generate, from the analysis data, control data for controlling a movement of a virtual object representing a performer; and
a display device configured to display the virtual object;
the information processing device including a display control module configured to make the display device display the virtual object from the control data.

12. The performance system according to claim 11, further comprising:
a performance control module configured to obtain the sound signal from the sound collecting device, and generate the performance data on a basis of the sound signal, wherein
the analysis data generating module obtains the performance data from the performance control module.

13. The performance system according to claim 12, further comprising:
an automatic performance device, wherein
the performance data is sequentially supplied from the performance control module to the automatic performance device to make the automatic performance device automatically play.
